(19) United States
(12) Patent Application Publication
(10) Pub. No.: US 2017/0158941 A1
(43) Pub. Date: Jun. 8, 2017

(54) ENVIRONMENTALLY FRIENDLY WELLBORE CONSOLIDATING/FLUID LOSS MATERIAL

(71) Applicant: SCHLUMBERGER NORGE AS, Sandnes (NO)

(72) Inventor: Anders Grinrod, Sandnes (NO)

(73) Assignee: SCHLUMBERGER NORGE AS, Sandnes (NO)

(21) Appl. No.: 15/371,401

(22) Filed: Dec. 7, 2016

Related U.S. Application Data
(60) Provisional application No. 62/264,748, filed on Dec. 8, 2015.

(51) Int. Cl. C09K 8/36; E21B 21/00; C09K 8/32

(52) U.S. Cl. CPC C09K 8/36; C09K 8/32; E21B 21/003; C09K 2208/04

(57) ABSTRACT

As disclosed herein, an oil-based fluid includes an oleaginous continuous phase, a non-oleaginous discontinuous phase, and a plurality of psyllium seed husks.

### CROSS REFERENCE TO RELATED APPLICATIONS

This application claims the benefit of U.S. Provisional Application No. 62/264,748 filed on Dec. 8, 2015, incorporated by reference herein in its entirety.

### BACKGROUND

During the drilling of a wellbore, various fluids are used in the well for a variety of functions. The fluids may be circulated through a drill pipe and drill bit into the wellbore, and then may subsequently flow upward through wellbore to the surface. During this circulation, a drilling fluid may act to remove drill cuttings from the bottom of the hole to the surface, to suspend cuttings and weighting material when circulation is interrupted, to control subsurface pressures, to maintain the integrity of the wellbore until the well section is cased and cemented, to isolate the fluids from the formation by providing sufficient hydrostatic pressure to prevent the ingress of formation fluids into the wellbore, to cool and lubricate the drill string and bit, and/or to maximize penetration rate.

The selection of the type of a wellbore fluid to be used in a drilling application involves a careful balance of both the good and bad characteristics of the wellbore fluids in the particular application and the type of well to be drilled. Frequently, the selection of a fluid may depend on the type of formation through which the well is being drilled. Wellbore fluid compositions may be water- or oil-based and may comprise weighting agents, surfactants, proppants, and polymers. However, for a wellbore fluid to perform its functions and allow wellbore operations to continue, the fluid may stay in the borehole. Frequently, undesirable formation conditions are encountered in which substantial amounts or, in some cases, practically the entire wellbore fluid may be lost to the formation. For example, wellbore fluid can leave the borehole through large or small fissures or fractures in the formation or through a highly porous rock matrix surrounding the borehole. Thus, fluid loss or lost circulation is a recurring drilling problem, characterized by loss of wellbore fluids into downhole formations that are fractured, highly permeable, porous, cavernous, or vugular or can be artificially induced by excessive mud pressures.

There is an analogous need to seal and prevent fluid loss when recovering hydrocarbons from sand formations, particularly depleted sand formations. Depleted sand formations are productive, or formerly productive, hydrocarbon zones that have been produced, drawn down, or otherwise depleted of their content, creating a lower formation pressure than that of the fluid which may be in use in the well. Because of this pressure differential, the sand formation may be partially or completely sealed to inhibit or prevent fluid loss of the mud into the sand.

To combat such mud losses into the formation, lost circulation treatments are attempted to plug or block the openings either naturally formed or induced by the drilling operation. Such lost circulation treatments have included a variety of treatment materials, including polymeric based treatments having sufficient strength and integrity to minimize lost circulation into voids in direct communication with the wellbore, such as fractures, fracture networks, vugs, washouts, cavities, and the like. For example, crosslinkable or absorbing polymers, loss control material (LCM) pills, and cement squeezes have been employed. These additives have found utility in preventing mud loss, stabilizing and strengthening the wellbore, and in zonal isolation and water shutoff treatments. Some typical viscosifying additives used in well fluids to combat fluid loss include natural polymers and derivatives thereof such as xanthan gum and hydroxyethyl cellulose (HEC). In addition, a wide variety of polysaccharides and polysaccharide derivatives may be used, as is known in the art.

Further, providing effective fluid loss control without damaging formation permeability in completion operations has been a prime requirement for an ideal fluid loss-control pill. Conventional fluid loss control pills include a variety of polymers or resins, calcium carbonate, and graded salt fluid loss additives, which have been used with varying degrees of fluid loss control. These pills achieve their fluid loss control from the presence of specific solids that rely on filter-cake build up on the face of the formation to inhibit flow into and through the formation. However, these additive materials can cause severe damage to near-wellbore areas after their application. This damage may reduce production levels if the formation permeability is not restored to its original level. Further, at a suitable point in the completion operation, the filter cake may be removed to restore the formation's permeability to its original level.

### DETAILED DESCRIPTION

Generally, embodiments disclosed herein relate to oil-based wellbore fluids and methods of using the same. More specifically, embodiments disclosed herein relate to oil-based wellbore fluids for downhole applications formed of an oleaginous continuous phase, a non-oleaginous discontinuous phase and a plurality of psyllium seed husks. It has been found that the presence of a plurality of psyllium seed husks in an oil-based wellbore fluid may provide fluid loss properties, allowing for water shut-off and fluid loss pill treatments without detrimentally altering the characteristics of the wellbore fluid.

The base fluids described herein may be oil-based wellbore fluids, such as an invert emulsion where a non-oleaginous discontinuous phase is emulsed within an oleaginous continuous phase. In one or more embodiments, the oleaginous continuous phase is selected from the group including petroleum oil, a natural oil, mineral oil, a synthetic oil, a silicone oil, such as hydrogenated and unhydrogenated olefins including polyalpha olefins, linear and branch olefins and the like, polydiorganosiloxanes, siloxanes, or organosiloxanes, esters of fatty acids, specifically straight chain, branched and cyclical alkyl ethers of fatty acids. Generally, the amount of the oleaginous phase may be sufficient to form a stable emulsion when utilized as the continuous phase. The amount of oleaginous phase in the invert emulsion fluid may vary depending upon the particular oleaginous phase used, the particular non-oleaginous phase used, and the particular application in which the invert emulsion fluid is to be employed. The amount of non-oleaginous phase in the invert emulsion fluid may vary depending upon the particular non-oleaginous phase used, the emulsifier selected to stabilize the non-oleaginous phase, and the particular application in which the invert emulsion fluid is to be employed. In one or more embodiments, the oil based fluid may contain up to 60 or 70 or 80 vol. % water or other non-oleaginous phase, and at least 20, 30, 40, 50, 60, or 70 vol. % of oleaginous phase. In some embodiments, the weight ratio of oleaginous phase to non-oleaginous phase may be from about 0.5 to 2.0.

As mentioned above, the wellbore fluid may be an invert emulsion having a continuous oleaginous phase and a non-oleaginous discontinuous phase (or liquid), such as an aqueous phase, among other substances and additives. Non-oleaginous liquids may, in some embodiments, include at least one of fresh water, sea water, brine, mixtures of water and water-soluble organic compounds, and mixtures thereof. In various embodiments, the non-oleaginous phase may be a brine, which may include seawater, aqueous solutions wherein the salt concentration is less than that of sea water, or aqueous solutions wherein the salt concentration is greater than that of sea water. Salts that may be found in seawater include, but are not limited to, sodium, calcium, aluminum, magnesium, potassium, strontium, and lithium salts of chlorides, bromides, carbonates, iodides, chlorates, bromates, formates, nitrates, oxides, sulfates, silicates, phosphates and fluorides. Salts that may be incorporated in a brine include any one or more of those present in natural seawater or any other organic or inorganic dissolved salts. Additionally, brines that may be used in the drilling fluids disclosed herein may be natural or synthetic, with synthetic brines tending to be much simpler in constitution.

The volume concentration of the non-oleaginous phase may affect the viscosity of an invert emulsion. Specifically, the higher the internal content, the higher the viscosity of the emulsion. Plastic viscosities in the range of 10-100 cP and yield stress in the range of 10-40 lb/100 ft² may be desirable for the formulation of the wellbore fluids of the present disclosure to prevent premature plug formation by the LCM materials. In yet another embodiment, the plastic viscosity may range from about 20 to about 50 cP, and the yield stress may range from about 10 to about 20 lb/100 ft².

The oil-based wellbore fluids of the present disclosure incorporate a plurality of psyllium seed husks. Psyllium seed husks are portions of the seed of the plant Plantago Ovata which are typically manufactured by separating the seed husk from the remainder of the seed by slight mechanical pressure, for example by crushing the seeds between rotating plates or rollers. Upon contact with water, the psyllium seed husks which are highly hydrophilic, may release a mucilaginous material or a gel, such as a thick gluey polar glycoprotein. The viscosity of the mucilaginous material is relatively unaffected between temperatures of 20 and 50 C (68 and 122 F), by pH from 2 to 10 and by salt (such as sodium chloride) concentrations up to 0.15 M.

According to the present embodiments, fluid loss control in a wellbore may be achieved by using psyllium seed husks as a fluid loss additive. According to various embodiments, the plurality of psyllium seed husks may be dispersed or suspended in an oleaginous continuous phase with the formation of a modified oleaginous continuous phase. Next, the modified oleaginous continuous phase may be mixed with a non-oleaginous discontinuous phase, with the formation of an invert emulsion, where the non-oleaginous discontinuous phase is dispersed or emulsed in the oleaginous continuous phase. As the psyllium seed husks are highly hydrophilic, they experience no swelling or gelling in the presence of the oleaginous continuous phase, being dormant in the wellbore fluid. It has been found that upon disruption of the invert emulsion by shearing when the wellbore fluid (such as a drilling fluid) is pumped through the nozzles of a drill bit into a wellbore, for example, the psyllium seed husks are exposed to the formation water with the formation of a mucilaginous gel which may act as a blockage or a seal that may prevent fluid loss. It is also envisioned that exposing the plurality of psyllium seed husks to water is performed by destabilization of the emulsion downhole. Compared with other conventional fluid loss additives, such as polyacrylamide, psyllium seed husks may be biodegradable and exhibit improved adhesive properties, yielding potential consolidation effects on loose material. It is also envisioned that the psyllium seed husks may be added directly to an active pit in the flow line carrying the invert emulsion wellbore fluid. Upon entering a lost circulation zone, the wellbore fluid containing the plurality of psyllium seed husk may form a seal or a plug at an entrance of a fracture, fissure or vug or inside a fracture, fissure or vug, thereby reducing the loss circulation.

The psyllium husk may be present in a wellbore fluid in an amount sufficient to enhance the viscous properties of the wellbore fluid, as well as for controlling the fluid loss behavior of the wellbore fluid into the well, upon contact with water. For example, in various embodiments, the psyllium seed husks may be present in the oil-based wellbore fluid in an amount that ranges from about 0.5 wt % to about 15 wt % of the total weight of the wellbore fluid. In various embodiments, when the wellbore fluid is a drilling fluid, the concentration of the psyllium seed husks in the wellbore fluid may be up to 100 g/l. It is also envisioned that when the oil-based wellbore fluid is a fluid loss pill, there is no limitation on the concentration of the psyllium seed husks. The wellbore fluids of the present disclosure may remain stable for a wide range of pH values, with negligible or no changes in the rheological and filtration properties.

According to various embodiments, the husk may be used “as is” or in various forms, such as unrefined psyllium seed husks, ground psyllium seed husks, or the like. In one or more embodiments, the psyllium seed husks may be coarse, coated or uncoated. As used herein, the term coated refers to any chemical or physical modification applied to the surface of the psyllium seed husks with the purpose of improving the dispersibility and/or the suspendability of the psyllium seed husks, as well as to modify their physical and/or chemical properties. As noted above, the addition of psyllium seed husks to a wellbore fluid results in the formation of a mucilaginous gel. As it will be described later, the chemical coating involves the use of various surfactants.

The size of psyllium seed husks used for formulation of the wellbore fluids of the present disclosure may affect the rate of water absorption with the formation of the mucilaginous gel. The smaller the size of the psyllium seed husks, the larger the surface area of the husks, yielding a higher absorption rate. However, the psyllium seed husks should not be so small that they negatively impact the rheology of the wellbore fluid. The rheology of the wellbore fluid may become negatively impacted if the particle size of the psyllium seed husks becomes comparable to that of the wellbore fluid solid constituents, i.e. weight material. In some embodiments, the psyllium seed husks are much bigger than the particles of weighting material, such as by orders of magnitude. Additionally, the psyllium seed husks should not be so small in size that they will pass through the shaker screens before they have swollen. In various embodiments, the psyllium seed husks may have a particle size distribution (PSD) ranging from about 4 mesh to about 400 mesh, such as when ground husks are used.

The wellbore fluids of the present application may further contain additional chemicals depending upon the end use of the fluid so long as they do not interfere with the functionality of the fluids (particularly the emulsion when using invert emulsion fluids) described herein. For example, weighting agents, emulsifiers, wetting agents, organophilic clays, viscosifiers, surfactants, dispersants, interfacial tension reducers, pH buffers, mutual solvents, thinners, thinning agents and cleaning agents may be added to the fluid compositions of this disclosure for additional functional properties.

Surfactants and wetting agents that may be suitable for use in the wellbore fluid include crude tall oil, oxidized crude tall oil, surfactants, organic phosphate esters, modified imidazolines and amidoamines, alkyl aromatic sulfates and sulfonates, and the like, and combinations or derivatives of these. However, when used with an invert emulsion fluid, the use of fatty acid wetting agents should be minimized so as to not adversely affect the reversibility of the invert emulsion disclosed herein. Faze-Wet™, VersaCoat™, SureWet™, SureMul™, Versawet™ and Versawet™ NS are examples of commercially available surfactants and wetting agents manufactured and distributed by M-I L.L.C. that may be used in the fluids disclosed herein.

Emulsifiers that may be used in the fluids disclosed herein include, for example, fatty acids, soaps of fatty acids, amidoamines, polyamides, polyamines, oleate esters, such as sorbitan monoleate, sorbitan dioleate, imidazoline derivatives or alcohol derivatives and combinations or derivatives of the above. Additionally, lime or other alkaline materials may be added to conventional invert emulsion drilling fluids and muds to maintain a reserve alkalinity.

Wetting agents that may be suitable for use in the fluids disclosed herein include crude tall oil, oxidized crude tall oil, surfactants, organic phosphate esters, modified imidazolines and amidoamines, alkyl aromatic sulfates and sulfonates, and the like, and combinations or derivatives of these.

Organophilic clays, normally amine treated clays, may be useful as viscosifiers and/or emulsion stabilizers in the fluid composition disclosed herein. Other viscosifiers, such as oil soluble polymers, polyamide resins, polycarboxylic acids and soaps can also be used. The amount of viscosifier used in the composition can vary upon the end use of the composition. However, normally about 0.1% to 6% by weight range is sufficient for most applications.

Conventional methods cart be used to prepare the wellbore fluids disclosed herein, in a manner analogous to those normally used to prepare conventional oil-based wellbore fluids. In one embodiment, a desired quantity of oleaginous fluid such as a base oil and a suitable amount of an emulsifier are mixed together and the remaining components are added sequentially with continuous mixing. An invert emulsion may also be formed by vigorously agitating, mixing or shearing the oleaginous fluid and the non-oleaginous fluid.

Upon mixing, the fluids of the present embodiments may be used in wellbore operations, such as base brines in drilling fluids, completion, fluid loss treatment or water-shutoff applications. Such operations are known to persons skilled in the art and involve pumping a wellbore fluid into a wellbore through an earthen formation and performing at least one wellbore operation while the wellbore fluid is in the wellbore.

One embodiment of the present disclosure involves a method of reducing loss of wellbore fluid in a wellbore to a formation. In one such illustrative embodiment, the method comprises pumping an oil-based wellbore fluid into a wellbore and exposing the plurality of psyllium seed husks to water in the base fluid of the wellbore fluid to form a mucilaginous gel. The wellbore fluid comprises an oleaginous continuous phase, a non-oleaginous discontinuous phase, and a plurality of psyllium seed husks. In various embodiments, the psyllium seed husks are suspended or dispersed in the oleaginous continuous phase. In one embodiment, the components of the wellbore fluid are simultaneously pumped into the wellbore. In another embodiment, the components of the wellbore fluid may be pumped sequentially. As such, in one embodiment of the present disclosure, the psyllium seed husks is introduced into the wellbore after initially pumping the base fluid, such as upon experiencing fluid loss to the formation. It is also envisioned that the formation of the mucilaginous gel occurs prior to reaching a lost circulation zone. It is also envisioned that the aqueous phase that causes the psyllium seed husks to swell is the discontinuous phase of the base fluid or formation waters.

In various embodiments, the wellbore fluid may be a drilling fluid which can be pumped into a wellbore through a plurality of nozzles of a drill bit. The shear forces generated by the passage of the wellbore fluid through a restriction, e.g. nozzles of a drill bit, may produce enough stress to disrupt the invert emulsion enough to expose the water or other non-oleaginous fluid present in the oil-based fluid to the psyllium seed husks which, upon contact with water may absorb water, with the formation of a mucilaginous gel, thus being able to assist in plugging a lost circulation zone.

In one or more embodiments, the wellbore fluid may be a fluid loss pill. In such embodiments, the fluid loss pill may be injected into a work string, flow to bottom of the wellbore, and then out of the work string and into the annulus between the work string and the casing or wellbore. This batch of treatment is typically referred to as a “pill.” The pill may be pushed by injection of other completion fluids behind the pill to a position within the wellbore which is immediately above a portion of the formation where fluid loss is suspected. The fluid loss pill may be selectively emplaced in the wellbore, for example, by spotting the pill through a coil tube or by bullheading. Injection of fluids into the wellbore is then stopped, and fluid loss will then move the pill toward the fluid loss location. Positioning the pill in a manner such as this is often referred to as “spotting” the pill. The fluid loss pill may then react with the brine to form a plug near the wellbore surface, to reduce fluid flow into the formation.

In one or more embodiments, fluid loss pills disclosed herein may have bridging solids incorporated therein to bridge or block the pores of a subterranean formation. For example, useful bridging solids may be solid, particulate, acid soluble materials, the particles of which have been sized to have a particle size distribution sufficient to seal off the pores of the formations contacted by the fluid loss pill fluids. Examples of bridging solids may include calcium carbonate, limestone, marble, dolomite, iron carbonate, iron oxide, and the like. However, other solids may be used without departing from the scope of the present disclosure. In some embodiments of fluid loss pills disclosed herein, bridging solids may have a specific gravity less than about 3.0 and may be sufficiently acid soluble such that they readily decompose upon release of the organic acid.

After completion of the drilling or completion process, filter cakes deposited by drilling and treatment fluids may be broken by application of a breaker fluid that degrades the constituents of the filter cake formed from drilling and/or a fluid loss pill. The breaker fluid may be circulated in the wellbore during or after the performance of the at least one completion operation. In other embodiments, the breaker fluid may be circulated either before, during, or after a completion operation has commenced to destroy the integrity of and clean up residual drilling fluids remaining inside casing or liners. The breaker fluid may contribute to the degradation and removal of the filter cake deposited on the sidewalls of the wellbore to minimize negatively impacting production. Upon cleanup of the well, the well may then be converted to production.

The breaker fluids of the present disclosure may also be formulated to contain an acid source to decrease the pH of the breaker fluid and aid in the degradation of filter cakes within the wellbore. Examples of acid sources that may be used as breaker fluid additives include strong mineral acids, such as hydrochloric acid or sulfuric acid, and organic acids, such as citric acid, salicylic acid, lactic acid, malic acid, acetic acid, and formic acid. Suitable organic acids that may be used as the acid sources may include citric acid, salicylic acid, glycolic acid, malic acid, maleic acid, fumaric acid, and homo- or copolymers of lactic acid and glycolic acid, as well as compounds containing hydroxy, phenoxy, carboxylic, hydroxycarboxylic or phenoxycarboxylic moieties. In one or more embodiments, before, during, or after a completion operation has started, or upon conclusion of the completion operations, the circulation of an acid wash may be used to at least partially dissolve some of the filter cake remaining on the wellbore walls.

Other embodiments may use breaker fluids that contain hydrolysable esters of organic acids and/or various oxidizers in combination with or in lieu of an acid wash. Hydrolysable esters that may hydrolyze to release an organic (or inorganic) acid may be used, including, for example, hydrolyzable esters of a C₁ to C₆ carboxylic acid and/or a C₂ to C₃₀ mono- or poly-alcohol, including alkyl orthoesters. In addition to these hydrolysable carboxylic esters, hydrolysable phosphonic or sulfonic esters could be utilized, such as, for example, R¹H₂PO₃, R¹R²HPO₃, R¹R²R³PO₃, R¹HSO₃, R¹R²SO₃, R¹H₂PO₄, R¹R²HPO₄, R¹R²R³PO₄, R¹HSO₄, or R¹R²SO₄, where R¹, R², and R³ are C₂ to C₃₀ alkyl-, aryl-, arylalkyl-, or alkylaryl-groups. One example of a suitable hydrolysable ester of carboxylic acid is available from MI-SWACO (Houston, Tex.) under the name D-STRUCTOR.

It should be appreciated that the amount of delay between the time when a breaker fluid according to the present disclosure is introduced to a well and the time when the fluids have had the desired effect of breaking/degrading/dispersing the filter cake may depend on several variables. One of skill in the art should appreciate that factors such as the downhole temperature, concentration of the components in the breaker fluid, pH, amount of available water, filter cake composition, etc. may have an impact on the breaking/degrading/dispersing of a filter cake. For example downhole temperatures can vary considerably from 100 F (37.7 C) to over 400 F (204.4 C) depending upon the formation geology and downhole environment. However, one of skill in the art via trial and error testing in the lab should easily be able to determine and thus correlate downhole temperature and the time of efficacy for a given formulation of the breaker fluids disclosed herein. With such information one can predetermine the time period to shut-in a well given a specific downhole temperature and a specific formulation of the breaker fluid.

Embodiments of the present disclosure provide oil-based wellbore fluids and associated methods using such fluids that include an oleaginous continuous phase, a non-oleaginous discontinuous phase and a plurality of psyllium seed husks. The wellbore fluids of the present disclosure have minimal environmental impact based on the inclusion of the psyllium husk seeds as the psyllium seed husks are non-toxic and biodegradable. The use of the psyllium seed husks in the wellbore fluids of the present disclosure, which, upon contact with water may form a blockage or a seal on the walls of the formation, and may allow for reducing fluid loss control. The wellbore fluids disclosed herein are useful in drilling, completion, water-shutoff, and other wellbore applications.

Although the preceding description has been described herein with reference to particular means, materials, and embodiments, it is not intended to be limited to the particulars disclosed herein; rather, it extends to all functionally equivalent structures, methods and uses, such as are within the scope of the appended claims.

What is claimed:

1. An oil-based wellbore fluid comprising:
an oleaginous continuous phase;
a non-oleaginous discontinuous phase; and
a plurality of psyllium seed husks.

2. The wellbore fluid of claim 1, wherein the oil-based continuous phase is selected from the group of petroleum oil, a natural oil, a synthetically derived oil, a mineral oil, a silicone oil, or a combination thereof.

3. The wellbore fluid of claim 1, wherein the plurality of psyllium seed husks is dispersed in the oleaginous continuous phase.

4. The wellbore fluid of claim 3, wherein the psyllium seed husks are coated or uncoated.

5. The wellbore fluid of claim 4, wherein the psyllium seed husks have a particle size distribution from about 4 mesh size to about 400 mesh size.

6. The wellbore fluid of claim 1, wherein the oil-based wellbore fluid is a drilling fluid.

7. The wellbore fluid of claim 6, wherein a concentration of the psyllium seed husks in the drilling fluid is up to 150 g/l.

8. The wellbore fluid of claim 1, wherein the oil-based wellbore fluid is a fluid loss pill.

9. A method of reducing loss of wellbore fluid in a wellbore to a formation, the method comprising:
pumping an oil-based wellbore fluid into a wellbore, the wellbore fluid comprising:
an oleaginous continuous phase;
a non-oleaginous discontinuous phase; and
a plurality of psyllium seed husks; and
exposing the plurality of psyllium seed husks to water.

10. The method of claim 9, wherein the plurality of psyllium seed husks is dispersed in the oleaginous continuous phase.

11. The method of claim 9, wherein exposing the plurality of psyllium seed husks to water is performed by destabilization of an emulsion downhole.

12. The method of claim 9, wherein exposing the plurality of psyllium seed husks to water causes the formation of a mucilaginous gel.

13. The method of claim 12, wherein the formation of the mucilaginous gel occurs prior to the reaching a lost circulation zone.

14. The method of claim 9, wherein pumping the oil-based wellbore fluid into a wellbore through a plurality of nozzles of a drill bit disrupts the non-oleaginous discontinuous phase.

15. The method of claim 9, further comprising allowing the psyllium seed husks to enter a lost circulation zone and to form a seal or a plug at an entrance of a fracture, fissure or vug or inside a fracture, fissure or vug, to reduce loss circulation into the wellbore.

16. The method of claim 9, wherein the psyllium seed husks are coated or uncoated.

17. The method of claim 9, wherein the psyllium seed husks have a particle size distribution from about 4 mesh size to about 400 mesh size.

18. The method of claim 9, wherein the wellbore fluid is a drilling fluid.

19. The method of claim 9, wherein a concentration of the psyllium seed husks in the drilling fluid is up to 150 g/l.

20. The method of claim 9, wherein the wellbore fluid is a fluid loss pill.
